(19) United States
(12) Patent Application Publication
(10) Pub. No.: US 2013/0238496 A1
(43) Pub. Date: Sep. 12, 2013

(54) SYSTEM AND METHOD FOR DOMAIN LEASING, ACQUISITION AND DEVELOPMENT INCORPORATING A VIRTUAL CURRENCY PLATFORM

(71) Applicants: Robert Monster, Sammamish, WA (US); John Lawler, Bellevue, WA (US)

(72) Inventors: Robert Monster, Sammamish, WA (US); John Lawler, Bellevue, WA (US)

(21) Appl. No.: 13/789,334

(22) Filed: Mar. 7, 2013

Related U.S. Application Data
(60) Provisional application No. 61/607,246, filed on Mar. 6, 2012.

(51) Int. Cl. G06Q 20/06

(52) U.S. Cl. CPC G06Q 20/06
USPC 705/40; 705/39; 705/307

(57) ABSTRACT

A system and method for a computer or web-based system designed to manage, track, and facilitate the use of virtual money as currency. They system allows for virtual currency to be used as a means to purchase and sell domain names, lease domain names, obtain domain name development services, obtain SEO counseling, and to purchase or sell products and services to or from third-party vendors who accept the virtual currency. Such transactions using virtual money could be considered “like kind” exchanges. The system also allows for the user to access and manage the user's virtual money as well as register, purchase, and sell domain names. The system can also be used to lease registered domain names whereby the domain name is locked during the duration of the lease so that the owner cannot sell or transfer the domain name while still allowing the lessee to control various aspect of the domain name.

### RELATED APPLICATION

This application claims priority to U.S. Provisional Patent Application 61/607246 filed on Mar. 6, 2012, entitled “System and Method for Domain Acquisition and Development Incorporating a Virtual Currency Platform”, the entirety of which is incorporated herein.

### BACKGROUND OF THE INVENTION

1. Field of the Invention

The present invention relates to the field of virtual currency exchange. More specifically, the invention relates to a system and method for leasing domain names and the use of virtual money as a means of currency to sell, purchase, and swap domain names, and related products and services.

2. Description of the Related Art

Each website, resource, and device, such as a computer, on the Internet has a unique Internet Protocol address (“IP address”). The user may locate a specific website using this IP address. Similar to a telephone number, each IP address consists of a complicated string of numbers. Because it can be difficult for users to memorize the complicated string of numbers, the Domain Name System (“DNS”) helps users navigate through the internet by assigning the complicated string of numbers a string of letters called a domain name. Like a phone book, the DNS translates or directs the easy to remember domain name to the appropriate IP address.

The domain name registry is a database of all domain names registered in a top-level domain (“TLD”), which is the highest level in the hierarchical DNS. Users may purchase domain names through various organizations and commercial entities, also known as domain name registrars, that sell, register, and manage the reservation of internet domain names. These domain name registrars are accredited by both the Internet Corporation for Assigned Names and Numbers (“ICANN”) and the generic top-level domain registry.

Typically, a user must pay a fee to a domain name registrar company in order to register his domain name on the domain name registry. A user may purchase a domain name, and later sell the domain name at a higher value using the domain registrar company. A user may also develop a website and direct or point the domain name to the website. A portion of the sales price typically goes to the domain name registrar company and toward taxes. Therefore, for each transaction, the user does not realize the full sales price value.

In order to minimize this loss, there is a need for an alternative payment method, such as using virtual money as currency for any and all domain-related transactions. The virtual money can be used to purchase other domain names, related services, and related products. In some cases, the transactions using virtual money can qualify as a tax deferred “like kind exchange.” In these situations, the user may not be obligated to pay taxes for each transaction relating to the purchasing and selling of domain names allowing the user to realize the full value of his transaction.

### SUMMARY OF THE INVENTION

This summary of the invention is provided to introduce concepts in a simplified form that are further described in the detailed description of the invention. This summary is not intended to identify key or essential inventive concepts of the claimed subject.

The present invention provides for a computer or web-based system designed to manage, track, and facilitate the use of virtual money as currency to purchase, sell, and lease domain names, obtain domain development services, obtain SEO counseling, and to purchase or sell products and services to or from third-party vendors who accept the virtual currency, such services may include legal services and products.

The system of the present invention can be accessed through the internet using a user's processor-based device. The system allows the user to access and manage the user's virtual money as well as register, purchase, sell, and lease domain names. The user's virtual money is held within a user's account or virtual wallet or bank.

The present invention also provides a system comprising at least one server with one or more software modules, wherein the system is configured to: receive a request from a first user to sell a first domain name; display the first domain name for sale on a website; receive a request from a second user to purchase the first domain name, wherein the first user receives virtual currency for the sale of the first domain name; transfer the virtual currency from an account of the second user to an account of the first user as stored in at least one database residing on the at least one server; receive a request from the first user to cash out at least some of the virtual currency for real currency; receive a request from the first user to purchase a second domain name; track the number of days between the first domain sale and the purchase of the second domain name by the first user; and provide a notification to the first user when the first domain sale and the second domain name purchase meet the criteria of a time based rule. The criteria for this system could be where the first domain name sale and the second domain name purchase fall within or outside a set number of days, e.g., 45 days. The system may further provide notice that the exchange of the first domain name sale and the second domain name purchase is a non-taxable event or a taxable event.

Another embodiment of the present invention could be a system comprising at least one server with one or more software modules, wherein the system is configured to: enable a first user with a domain name associated with a first domain name registrar to post the availability of the domain name for lease on a website associated with the one or more servers; receive a lease commitment from a second user to lease the domain name; and lock the domain name to prevent the first user and the second user from transferring the domain name to a second domain name registrar. Further, this system and at least one server may be associated with the first domain name registrar. After the system is locked, the second user could have access to change one or more domain name settings, including but not limited to: (1) DNS settings; (2) host records; (3) domain forwarding; (4) email forwarding; (5) hosting management; (6) creating subdomains; (7) registering name servers; (8) MX Records; (9) TXT Records; (10) A Records; (11) NS Records; (12) CNAME Record; and (13) Privacy Settings. Further, the system can unlock the domain name upon the occurrence of an event, such as the ending of the lease, or breach of a lease term, i.e., failure to pay a fee associated with the domain name lease. As part of this leasing system, the second user could pay a fee associated with the domain name lease and such fee could be paid with virtual dollars.

These and other objects, features, and/or advantages may accrue from various aspects of embodiments of the present invention, as described in more detail below.

### BRIEF DESCRIPTION OF THE DRAWINGS

The foregoing summary, as well as the following detailed description of the invention, is better understood when read in conjunction with the appended drawing. For the purpose of illustrating the invention, exemplary constructions of the invention are shown in the drawings. However, the invention is not limited to the specific methods and instrumentalities disclosed herein.

FIG. 1 exemplarily illustrates a flow diagram of the present invention.

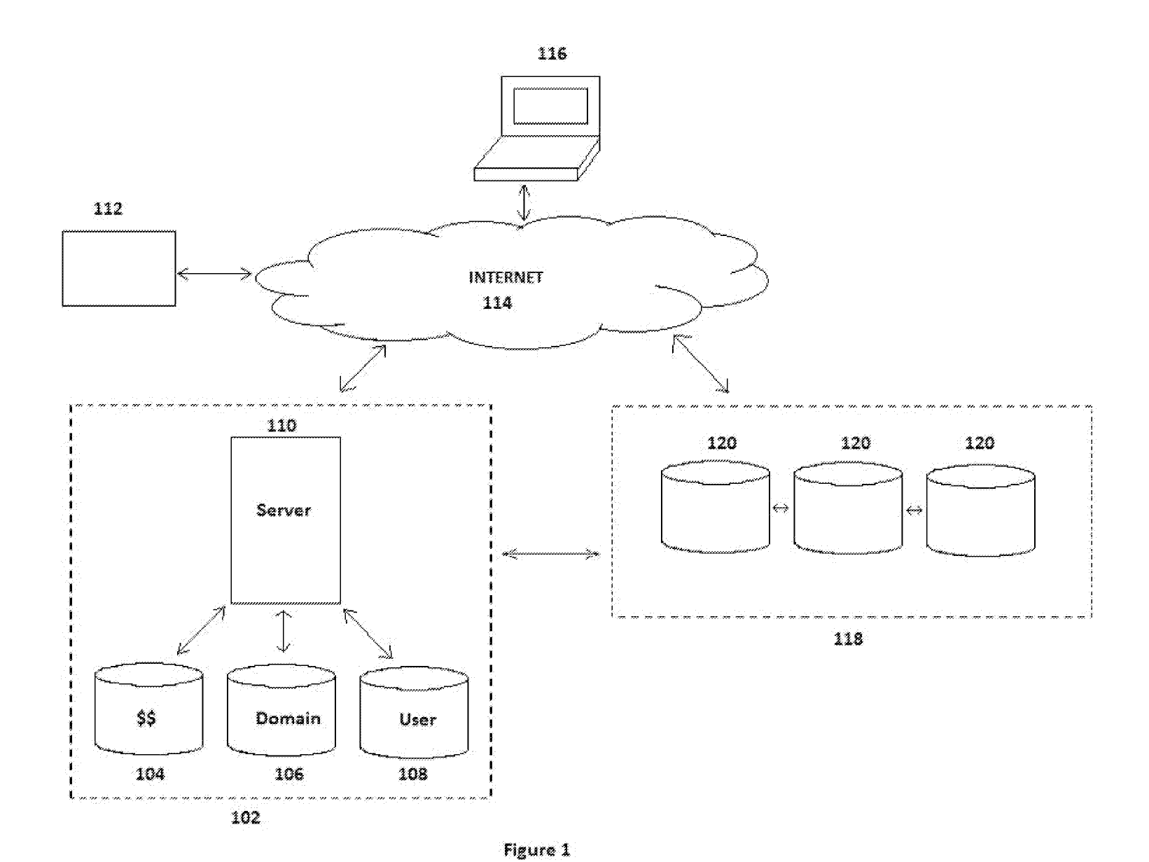

FIG. 2 exemplarily illustrates a flow diagram of purchasing domain names, obtaining domain development services and products, and selling domain names using the present invention.

FIG. 3 exemplarily illustrates a flow diagram of the domain name leasing steps through the system of the present invention.

FIG. 4 illustrates a flow diagram of the domain name leasing combined with the use of virtual currency to mitigate taxable events.

### DETAILED DESCRIPTION OF EXEMPLARY EMBODIMENTS

Particular embodiments of the present invention will now be described in greater detail with reference to the figures.

The present invention provides for a main system 102 which comprises of one or more servers 110 connected to one or more databases 104, 106, 108.

The databases 104, 106, 108 of the main system 102 are comprised of: (1) one or more databases or tables 104 used to store information related to the virtual money and virtual currency (hereinafter referred to as the “virtual money database”); (2) one or more databases or tables 106 used to store information related to domain name registrations (hereinafter referred to as the “domain name database”); and (3) one or more databases or tables 108 used to store information related to user information (hereinafter referred to as the “user information database”).

Various applications, software, and programs reside on the one or more servers 110 that allow the user to access the system's web interface, the marketplace application, the services application, the products application, and the domain name registration application.

The domain name registration application allows a user to purchase or lease domain names through the system. The domain name registration application allows users to purchase or lease domain names registered with the company running the system or with other domain name registrar companies. A user may remotely access the system 102 and the domain name application residing on the server 110 through the internet 114 using the user's remote processor-based device 116. Using the system's 102 graphical user interface (“GUI”), the user may purchase or lease a domain name using either virtual money or real money. If the user purchases or leases a domain name using virtual money, the server 110 retrieves the user's information from the user information database 108 and the user's virtual money information from the virtual money databases 104. One or more applications residing on the server 110 updates the user's account on the virtual money databases 104 to reflect the user's purchase(s).

Concurrently, as the user purchases or leases a domain name, the system 102 registers the domain name with the domain name registry 118. The domain name registry 118 consists of one or more databases 120 of all registered Top-Level Domains.

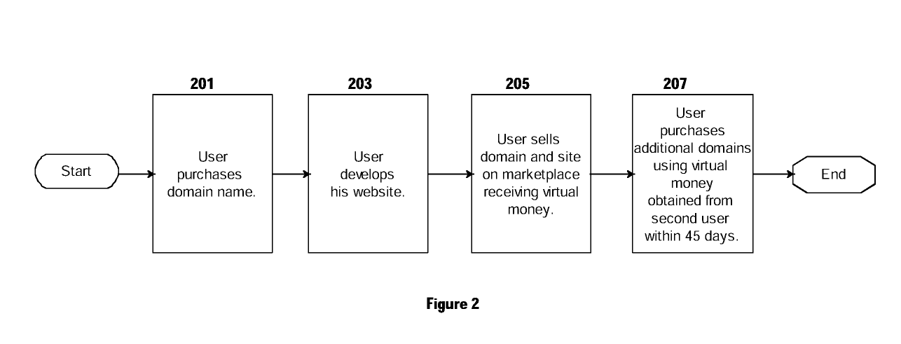

FIG. 2 depicts a flow chart of a user using the system to receive and spend virtual bucks on domain name acquisition and development activities to gain a tax advantage or deferral. In step 201, the user purchases a domain name. In step 203, the user develops or enhances the website associated with the domain name. The user may develop and improve his website on his own or use services and products purchased either through the present invention or external sources. In step 205, the user decides to sell the domain name and website on the marketplace application. In return for his sale, the user receives virtual money. In step 207, the user uses the virtual money he received from the sale in step 205 to purchase additional domain names within 45 days of the sale in step 205. Taken together, these additional domain names are worth the same in value as the domain name sold in step 205. Because the user purchased the additional domains names within 45 days of selling the domain na,e in step 205 and the additional domain names together are valued the same or greater than the domain name sold in step 205, a like kind tax advantage applies to these transactions. Under IRC section 1031, swapping domain names using virtual money qualifies as a tax deferred “like kind exchange.”

By way of example, a user logs onto his computer 116 and connects to the system 102 through the internet 114. The user searches for a domain name using the domain name application until he finds an available domain name to purchase. The user logs into his account which, for this example, has a total of $300 virtual bucks. The user purchases the domain name, Domain A, with $8 virtual bucks. An application on the server 110 updates the virtual money database 104 to reflect $292 virtual bucks remaining in the user's account.

Using the marketplace application resident on the one or more system servers 110, the user may purchase, sell, and swap domain names using either virtual money or real money. The user may also use virtual money or real money to purchase website domain services, SEO consulting services, and other similar services.

Continuing with the example above, the user accesses the system 102 through the internet 114 using his computer 116 and purchases services, such as services from a website development company, to help develop his website and the functionality of his website. For purposes of this example, the user further hires a graphic artist using virtual bucks to develop the graphical logos and the graphical user interface of the website for $100 virtual bucks. Lastly, the user hires an SEO consultant using virtual bucks to optimize the domain name for its targeted keywords.

After each transaction, an application updates the user's account information to reflect the remaining virtual bucks in his account. For the services and products purchased from each third-party vendor, for example from a website developer or an SEO consultant, the application updates vendors' accounts to reflect the additional virtual bucks. The system also notifies the vendors and user of the transaction.

For purposes of this example, due to the investments the user has placed into the development of his website, Domain A's value increased substantially to a worth of $2,000 U.S. dollars and the user has the option of selling the domain name for more than he originally paid. Using the marketplace application resident on the one or more system servers 110, the first user, who owns Domain A, decides to sell the domain name and website. A second user accesses the marketplace application using her computer 116, and decides to purchase Domain A from the first user using $2,000 virtual bucks. An application on server 110 transfers the $2,000 virtual bucks to the first user's account, and also transfers the domain name to the second user's account. The next day, the first user in step 211 accesses the marketplace application using his computer 116 and purchases four more domain names valued at $500 virtual bucks each.

As discussed above, because the first user purchased the additional domain names within 45 days of selling Domain A and the additional domains together are valued the same as Domain A, a tax advantage applies to these transactions. Thus, by using virtual bucks to purchase the domain name and to purchase services in developing the domain name, the user not only profited from the increased value of the website, but also gained a tax advantage or deferral.

In another exemplary embodiment, the system may be used to lease registered domain names. The system for leasing a domain name has several important aspects related to domain control. Primarily, the system needs to allow the lessee to point the domain name to his IP address so that it displays his website during the lease period while providing certainty that the domain is not sold or transferred during the lease period. As can be understood, the lessee does not want to build a site around a leased domain name which increases the value of the domain name only to see it sold or transferred. Further, most lessees want the ability to test the domain name for its value as a precursor to purchasing the domain. Thus, the lessee wants to know the domain name is locked during the lease period and that they might have some first right of purchase. The domain name owner or lessor wants to generate revenue from his domain names and possibly sell his domain name for value.

The present invention solves these issues by providing a system that enables the lessee to control various aspects of the domain name, such as where the domain name points, DNS settings and other elements related to the domain name, but not the ownership aspects of the domain name.

The system therefore provides a solution which locks the domain name for the length of the lease period preventing the domain name owner from transferring the domain name to another registrar or to another owner. The system also provides the functionality to allow the lessor and lessee to agree upon a sales price for the domain name, which would allow the lessee to purchase the domain name at any time during the lease period. Therefore, the lessee has the option to purchase and take ownership of the domain name, thus ending the lease, and having the domain name transferred. The lessee and lessor will agree on a lease fee which is incorporated into the lease agreement. The fee may be monthly, quarterly, or yearly and may be paid with real dollars or virtual dollars. In either event, the funds are transferred to the lessor's account. The system operator may charge a fee for the leasing service which may be a flat fee, a subscription fee, or a percentage of the rental and/or sales fee. The lessee and lessor may also agree on a purchase price for the domain name which may be negotiated along with the lease fee and agreement, or may be negotiated any time after the lease agreement was initiated. Again, the lessor and lessee may agree that such funds will be in the form of real dollars or virtual dollars.

The system also accounts for failed lease payments or breaches of the lease agreement as such would violate the domain name lease agreement. Such a breach or violation which would trigger an unlock event allowing the lessor or domain name owner to then control the domain name settings including pointing the domain name to a new or different IP address as well as the ability to sell or transfer the domain to a third party or transfer the domain name to a new registrar.

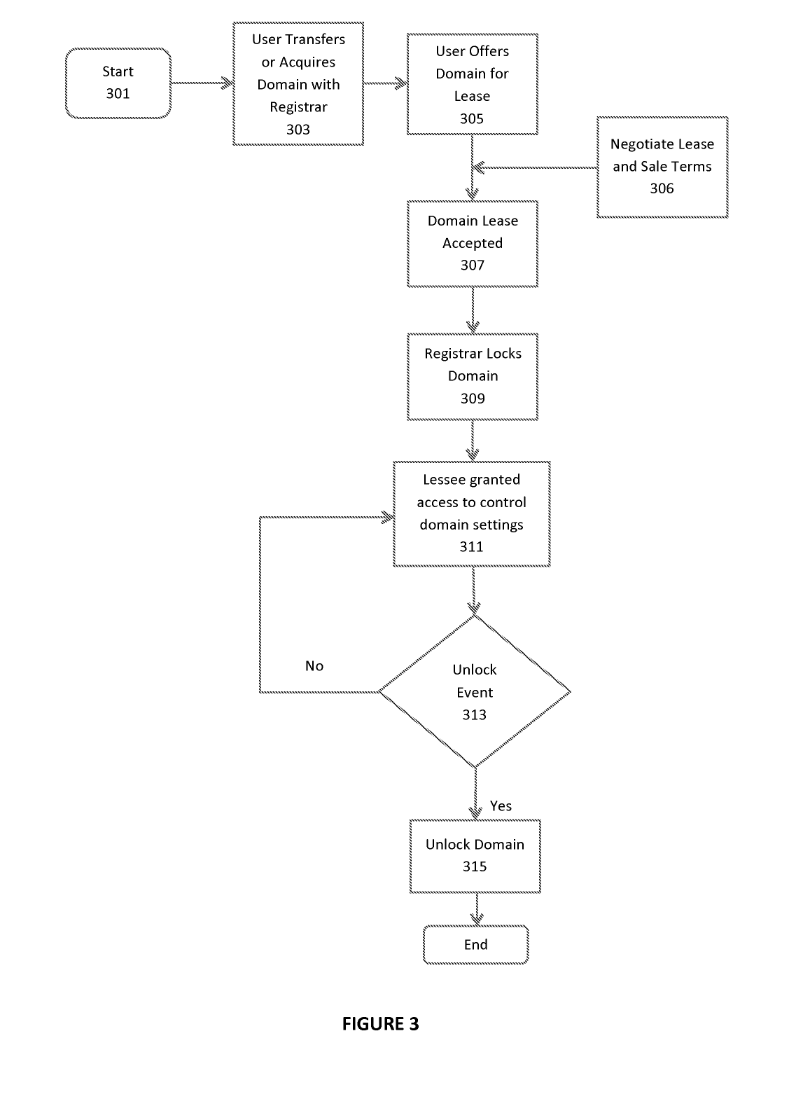

As seen in FIG. 3, the process or method starts at step 301. The user then acquires a domain with the registrar or transfers the domain name to the registrar in step 303. The domain name owner then offers the domain name for lease in step 305. In step 306, the owner or lessor and the lessee negotiate and finalize the lease terms such as the length of the lease, the lease rate, payment terms, and a purchase price. The lessee then accepts the lease in step 307. Once the lease has been accepted the system or registrar locks the domain in step 309. Once the domain name is locked in step 309, the system grants access to control the various domain name settings in step 311. The domain name remains locked until there is an event which causes the domain name to be unlocked as seen in step 313. If there is an unlock event, the domain name is unlocked in step 315. If there is not an unlock event, the lessee retains control of the available domain name settings. As further described herein, the unlock events may be the end of the lease term or a breach of the payment terms.

Ideally, the domain name leasing system is a closed system integral or connected to a domain name registrar who allows the system to lock the leased domain name so that the domain name owner cannot sell or transfer the domain name during the lease period and allows the lessee to control aspects of the domain name during the duration of the lease.

Upon the leasing of a domain name, the lessee has all normal registrar and domain management capabilities except they cannot: (1) see the authorization code(s) associated with the domain; (2) change the WHOIS settings; and (3) transfer or push the domain to another user. Other than those restrictions, the domain name can be controlled by the lessee enabling them to point and change the domain name settings to meet their needs. Such needs may be website related, email related or other. Depending on the settings set by the system, the lessee would be able to update or change some or all of the following: (1) DNS or Domain Name System settings; (2) host records; (3) domain forwarding; (4) email forwarding; (5) hosting management; (6) creating subdomains; (7) registering name servers; (8) MX Records; (9) TXT Records; (10) A Records; (11) NS Records; (12) CNAME Record; and (13) Privacy Settings. However, the only party capable of updating the WHOIS or authorization code during the locked lease period is the registrar. In effect, the registrar, or system provider, functions as an escrow agent, sitting in between the lessor and lessee during the agreed lease term to hold the domain name and prevent either party from transferring or moving the domain name.

The leasing feature of the present invention can also be used in combination with the virtual dollars and the like kind exchange feature enabling a user to purchase domain names, lease those domain names, and then sell those domain names taking virtual dollars. Those virtual dollars can then be used to purchase or develop other domains while minimizing their tax impact until the virtual dollars are cashed out for real dollars.

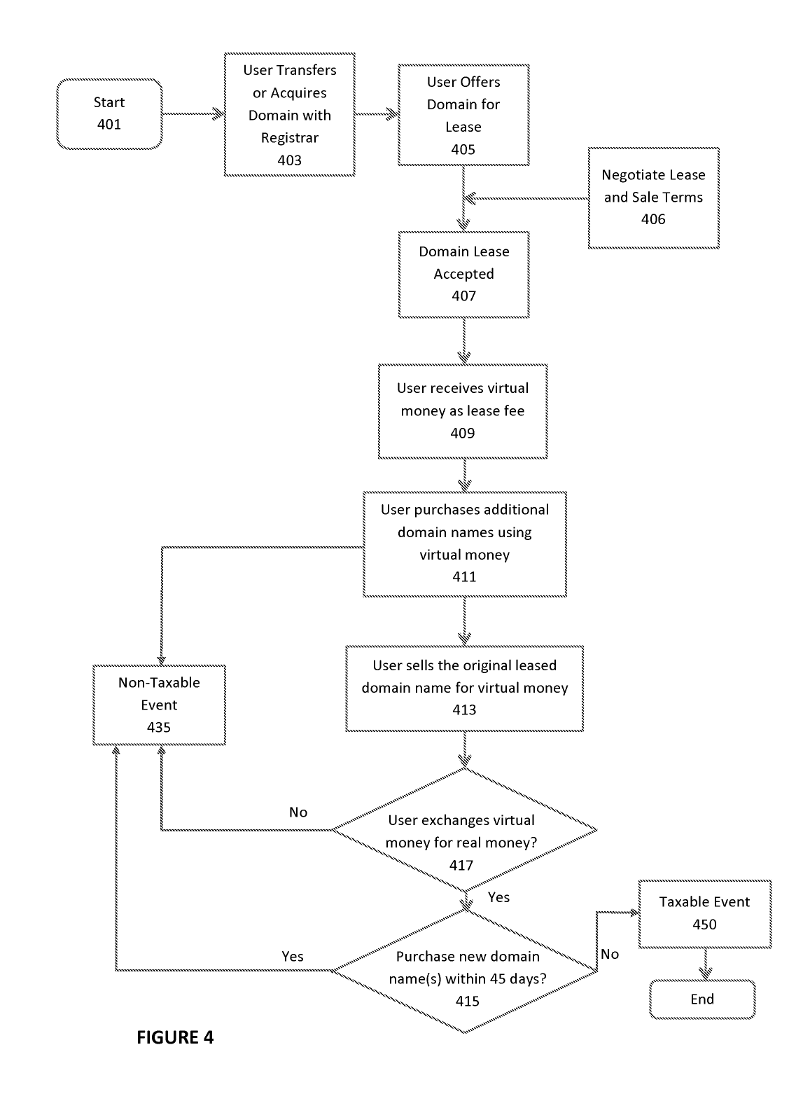

By way of example and as depicted in FIG. 4, the first user or domain name owner starts in step 401 by transferring or acquiring a domain name with a registrar step 403. The user offers the domain name for lease in step 405. The terms of the lease agreement including a sale price may be negotiated in step 406 and the user enters into an agreement to lease the domain name to the second user, i.e., lessee in step 409. The lessee can pay the rental fee and the lessor accepts the rental fee with virtual money drawn from the lessee's account and applied to the lessor's account. The lessee develops or enhances the website associated with the domain name. The lessee may develop and improve his website on his own or use services and products purchased either through the system of the present invention using virtual or real money or through external sources. The lessor or domain name owner can use the virtual rental money he receives from the domain name rental to purchase, develop, or maintain additional domains in step 411. Because the additional domain name purchases and development occurred with virtual money the virtual dollars are a non-taxable event step 435. During the lease or when the lease is up, the lessee may purchase the domain name from the owner, extend the lease, or relinquish his rights to the domain name at the end of the lease term. If the lessee purchases the domain or the lessor sells the original leased domain for virtual money step 413 additional virtual funds would be transferred from the lessee to the lessor's virtual money account. If the lessor does not exchange the virtual money for real money in step 417 it is a non-taxable event 435. If the user or domain name owner “cashes out” and exchanges the virtual money for real money we need to determine if the domain owner purchased new domains within 45 days to qualify for a like kind exchange. If the domain owner did purchase new domains the sale of the original leased domain is a non-taxable event step 435. If the domain owner did not purchase new domain names within 45 days the cashed out exchange would become a taxable event step 450.

In addition to exchanging the virtual money with other users, the user may also exchange the virtual money for real money. When exchanging the virtual money for real money, the system 102 may provide the ability to allow the user to convert the virtual money into real money or allow other users to purchase the virtual currency at a negotiated price. Either option would be considered a “cash out” event for the user for which taxes may apply depending on the amount invested in and amount cashed out.

The system also enables a user to manage, develop, and sell domain names registered with third party registrars. By way of example, a first user uses the system to sell Domain B and Domain C. Both Domain B and Domain C are registered with different domain name registrar companies. Using an application on the system, the user is able to view Domain B and Domain C in a list of domains he currently owns and sell these domain names in the marketplace. The user may also set the price he wants to sell Domain B and Domain C. A second user accesses the system and enters the marketplace. From the marketplace platform, the second user is able to search for Domain B and Domain C and purchase these domains even though the Domain B and Domain C are registered with different domain name registrar companies. The funds for purchasing the domain names may be held in a virtual escrow account until the first user goes to his other registrar and processes the transfer. Upon completion of the transfer the virtual dollars would then be added to the first user's account.

The examples provided herein are merely for the purpose of explanation and are in no way to be construed as limiting of the present method and product disclosed herein. While the invention has been described with reference to various embodiments, it is understood that the words which have been used herein are words of description and illustration, rather than words of limitation. Further, although the invention has been described herein with reference to particular means, materials, and embodiments, the invention is not intended to be limited to the particulars disclosed herein; rather, the invention expands to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

It will be recognized by those skilled in the art that changes or modifications may be made to the above described embodiment without departing from the broad inventive concepts of the invention. It is understood therefore that the invention is not limited to the particular embodiment which is described, but is intended to cover all modifications and changes within the scope and spirit of the invention.

1. A system comprising:
at least one server with one or more software modules, wherein the system is configured to:
receive a request from a first user to sell a first domain name;
display the first domain name for sale on a website;
receive a request from a second user to purchase the first domain name, wherein the first user receives virtual currency for the sale of the first domain name
transfer the virtual currency from an account of the second user to an account of the first user as stored in at least one database residing on the at least one server;
receive a request from the first user to cash out at least some of the virtual currency for real currency;
receive a request from the first user to purchase a second domain name;
track the number of days between the first domain name sale and the purchase of the second domain name by the first user; and
provide a notification to the first user when the first domain name sale and the second domain name purchase meet the criteria of a time based rule.

2. The system of claim 1, wherein the criteria is the first domain name sale and the second domain name purchase falls within a set number of days.

3. The system of claim 2, wherein the number of days is set at 45 days.

4. The system of claim 2, wherein the notification is a notice that the exchange of the first domain name sale and the second domain name purchase is a non-taxable event.

5. The system of claim 1, wherein the criteria is the first domain name sale and the second domain name purchase falls outside a set number of days.

6. The system of claim 5, wherein the number of days is set at 45 days.

7. The system of claim 5, wherein the notification is a notice that the exchange of the first domain name sale and the second domain name purchase is a taxable event.

8. A system comprising:
at least one server with one or more software modules, wherein the system is configured to:
enable a first user with a domain name associated with a first domain name registrar to post the availability of the domain name for lease on a website associated with the one or more servers;
receive a lease commitment from a second user to lease the domain name; and
lock the domain name to prevent the first user and the second user from transferring the domain name to a second domain name registrar.

9. The system of claim 8, wherein the system and at least one server are associated with the first domain name registrar.

10. The system of claim 9, wherein after the domain name has been locked the second user has access to change one or more domain name settings.

11. The system of claim 10, wherein the one or more settings is one of: (1) DNS settings; (2) host records; (3) domain name forwarding; (4) email forwarding; (5) hosting management; (6) creating subdomains; (7) registering name servers; (8) MX Records; (9) TXT Records; (10) A Records; (11) NS Records; (12) CNAME Record; and (13) Privacy Settings.

12. The system of claim 8, wherein system can unlock the domain name upon the occurrence of an event.

13. The system of claim 12, wherein the event is the ending of the lease.

14. The system of claim 12, wherein the event is a breach of a lease term.

15. The system of claim 14, wherein the breach is a failure to pay a fee associated with the domain name lease.

16. The system of claim 8, wherein the second user pays a fee associated with the domain name lease.

17. The system of claim 16, wherein the fee is paid with virtual dollars.
